(19) United States
(12) Patent Application Publication
(10) Pub. No.: US 2012/0231372 A1
(43) Pub. Date: Sep. 13, 2012

(54) METALLIC BIPOLAR PLATE FOR FUEL CELL AND METHOD FOR FORMING SURFACE LAYER THEREOF

(75) Inventors: In Woong Lyo, Suwon (KR); Jeong Uk An, Seoul (KR); Sung Moon Choi, Hwaseong (KR); Seung Gyun Ahn, Suwon (KR); Young Min Nam, Siheung (KR); Yoo Chang Yang, Gunpo (KR)

(73) Assignee: HYUNDAI MOTOR COMPANY, Seoul (KR)

(21) Appl. No.: 13/477,898

(22) Filed: May 22, 2012

Related U.S. Application Data
(62) Division of application No. 12/364,566, filed on Feb. 3, 2009.

(30) Foreign Application Priority Data
Jul. 17, 2008 (KR) 10-2008-0069773

(51) Int. Cl. H01M 8/04; B05D 5/12

(52) U.S. Cl. 429/514; 427/115

(57) ABSTRACT

A metallic bipolar plate for a fuel cell, in which a carbon coating layer containing fluorine is formed on the surface of a stainless steel base material, thus having excellent electrical conductivity and corrosion resistance and further excellent water draining performance and heat radiating performance. In the metallic bipolar plate for a fuel cell of the present invention, the internal residual stress in the surface coating layer is significantly reduced due to the addition of fluorine, and thereby it is possible to improve the adhesive strength between the stainless steel and the surface coating layer.

### CROSS-REFERENCE TO RELATED APPLICATION

This application claims under 35 U.S.C. §119(a) the benefit of Korean Patent Application No. 10-2008-0069773 filed Jul. 17, 2008, the entire contents of which are incorporated herein by reference.

### BACKGROUND

(a) Technical Field

The present invention relates to a metallic bipolar plate for a fuel cell and a method for forming a surface layer thereof, in which a carbon coating layer containing fluorine is formed on the surface of a stainless steel base material of the bipolar plate.

(b) Background Art

A fuel cell system generates electrical energy by electrochemically converting chemical energy derived from a fuel directly into electrical energy by oxidation of the fuel.

A typical fuel cell system comprises a fuel cell stack for generating electricity by electrochemical reaction, a hydrogen supply system for supplying hydrogen as a fuel to the fuel cell stack, an oxygen (air) supply system for supplying oxygen containing air as an oxidant required for the electrochemical reaction in the fuel cell stack, a thermal management system (TMS) for removing reaction heat from the fuel cell stack to the outside of the fuel cell system, controlling operation temperature of the fuel cell stack, and performing water management function, and a system controller for controlling overall operation of the fuel cell system. The fuel cell system generates heat and water as well as electricity.

One of the most attractive fuel cells for a vehicle is a proton exchange membrane fuel cell or a polymer electrolyte membrane fuel cell (PEMFC), which has the highest power density among known fuel cells. The PEMFC is operated in a low temperature and is able to start up in a short time and has a fast reaction time for power conversion.

The fuel cell stack included in the PEMFC comprises a membrane electrode assembly (MEA), a gas diffusion layer (GDL), a gasket, a sealing member, and a bipolar plate separator. The MEA includes a polymer electrolyte membrane through which hydrogen ions are transported. An electrode/catalyst layer, in which an electrochemical reaction takes place, is disposed on each of both sides of the polymer electrolyte membrane. The GDL functions to uniformly diffuse reactant gases and transmit generated electricity. The gasket functions to provide an appropriate airtightness to reactant gases and coolant. The sealing member functions to provide an appropriate bonding pressure. The bipolar plate separator functions to support the MEA and GDL, collect and transmit generated electricity, transmit reactant gases, transmit and remove reaction products, and transmit coolant to remove reaction heat, etc. Moreover, the bipolar plate have channels thereon through which hydrogen and oxygen (or oxygen containing air) are supplied and water generated from the electrochemical reaction is discharged and in which hydrogen and oxygen are in continuous contact with each other.

The fuel cell stack is consisted of a plurality of unit cells, each unit cells including an anode, a cathode and an electrolyte (electrolyte membrane). Hydrogen is supplied to the anode (also called “fuel electrode,” “hydrogen electrode,” or “oxidation electrode”) and oxygen containing air is supplied to the cathode (also called “air electrode,” “oxygen electrode,” or “reduction electrode”).

The hydrogen supplied to the anode is dissociated into hydrogen ions (protons, H⁺) and electrons (e⁻) by a catalyst disposed in the electrode/catalyst layer. The hydrogen ions are transmitted to the cathode through the electrolyte membrane, which is a cation exchange membrane, and the electrons are transmitted to the cathode through the GDL and the bipolar plate.

At the cathode, the hydrogen ions supplied through the (polymer) electrolyte membrane and the electrons transmitted through the bipolar plate react with the oxygen containing air supplied to the cathode to produce water.

Migration of the hydrogen ions cause electrons to flow through an external conducting wire, which generates electricity and heat.

The electrode reactions in the PEMFC can be represented by the following formulas:

Reaction in the fuel electrode: 2H₂→4H⁺+4e⁻

Reaction in the air electrode: O₂+4H⁺+4e⁻→2H₂O

Overall reaction: 2H₂+O₂→2H₂O+electrical energy+heat energy

In order to improve the efficiency of the fuel cell, the bipolar plate should have characteristics such as excellent corrosion resistance, airtightness, chemical stability, thermal conductivity and water draining performance.

Conventional bipolar plates are formed of a graphite material or a composite graphite material, in which resin and graphite are mixed, having excellent electrical conductivity and chemical stability. However, the graphite bipolar plate has drawbacks in that it has mechanical strength and airtightness lower than those of a metallic bipolar plate and has high manufacturing cost and low productivity since the manufacturing process is performed manually due to its fragility.

Accordingly, extensive research aimed at substituting the graphite bipolar plate by a metallic bipolar plate has been conducted.

However, the metallic bipolar plate tends to be corroded over time. The corrosion may contaminate the MEA and increase the internal resistance, thus decreasing the efficiency of the electrochemical reaction. Moreover, it may impede smooth drainage of water, thus deteriorating the performance of the fuel cell stack. Further, it may gradually reduce the output voltage and as a result, which may cause the function of the entire fuel cell to stop.

Accordingly, various methods have been proposed to improve the surface of the metallic bipolar plate.

One of the methods is to coat carbide or nitride (e.g., chromium nitride (CrN) or titanium nitride (TiN)) on the surface of the stainless steel bipolar plate by physical vapor deposition (PVD). Another method is to modify the surface by carburizing or nitriding (e.g., forming a nitride layer on the surface by plasma nitridation at a temperature below 600° C.).

The methods, however, have drawbacks. For example, the CrN coating layer formed by the physical vapor deposition has a relatively high contact resistance and its manufacturing cost is high. In addition, the PVD coating of CrN, TiN, etc. requires a high vacuum process and it has limitations in terms of manufacturing cost and mass productivity.

Meanwhile, the surface modification method such as nitriding may deteriorate the characteristics of the base material, and thus reduce the corrosion resistance. In case of the surface nitride layer formed by the plasma nitridation, chromium of the base material is consumed to the surface nitride layer, thereby producing a chromium depletion layer having numerous pores on the surface thereof, which results in decrease in the corrosion resistance of the surface layer. Moreover, if a thick oxide is formed on the surface layer, the contact resistance of the surface is excessively increased, and thus the bipolar plate no longer functions.

Accordingly, surface treatment methods that can prevent the nitration of chromium and the formation of an oxidation layer in a low temperature process and improve the corrosion resistance by minimizing surface defects have been proposed.

For example, Japanese Patent Application Publication No. 2000-353531 discloses a technique for forming a chromium nitride such as CrN, Cr₂N, CrN₂ and Cr(N₃)₃ by coating chromium on the surface of a base material and then performing a nitriding process. To ensure mass production and reduce manufacturing costs, the temperature and time of the nitriding process must be reduced. If the temperature and time of the nitriding process are reduced, however, it is difficult to ensure a desired corrosion resistance.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with prior art. Accordingly, the present invention provides a new surface coating method, which can improve the electrical conductivity, corrosion resistance, and water draining performance of a metallic bipolar plate for a fuel cell.

In one aspect, the present invention provides a metallic bipolar plate for a fuel cell comprising a carbon coating layer formed on the surface of a stainless steel base material thereof, wherein the carbon coating layer contains 25 to 35 at. % of fluorine.

In another aspect, the present invention provides a method for forming a surface layer of a metallic bipolar plate for a fuel cell. Preferably, a carbon coating layer containing 25 to 35 AT. % of fluorine is formed on the surface of a stainless steel base material for a fuel cell bipolar plate by a plasma assisted chemical vapor deposition.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a schematic diagram showing a structure of a metallic bipolar plate for a fuel cell in which the surface of a stainless steel base material is doped with fluorine and coated with carbon in accordance with the present invention;

FIG. 2 is a diagram showing measurement result of surface energy and contact angle with respect to fluorine content;

FIG. 3 is a diagram showing measurement result of waterdrop contact angle on the surface of a bipolar plate including a carbon coating layer doped with fluorine in accordance with the present invention and on the surface of a bipolar plate including no carbon coating layer;

FIG. 4 is a diagram showing a reduction in residual stress and an increase in adhesive strength in a carbon coating layer with respect to fluorine content;

FIG. 5 is a diagram showing measurement result of corrosion resistance in accordance with an example and a comparative example; and

FIG. 6 is a diagram showing measurement result of contact resistance in accordance with the example and the comparative example.

Reference numerals set forth in the Drawings includes reference to the following elements as further discussed below:

| | |
|---|---|
| 11: stainless steel base material | 12: carbon coating layer |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

According to the present invention, the electrical conductivity, corrosion resistance, and water draining performance of a metallic bipolar plate for a fuel cell can be improved by forming a carbon coating layer doped with fluorine on the surface of a stainless steel base material the bipolar plate.

Without intending to limit the theory, the electrical conductivity is increased by carbon and the surface energy is decreased by fluorine. The decreased surface energy inhibits a reaction with oxygen, making it possible to improve the corrosion resistance. Furthermore, the decreased surface energy prevents product water from adhering to the surface, thereby improving water draining performance. In addition, the decreased surface energy reduces the contact area with water, thus facilitating heat radiation from the surface. Additionally, the fluorine doped into the carbon coating layer reduces residual stress in the carbon coating layer, thus improving the adhesive strength with the bipolar plate.

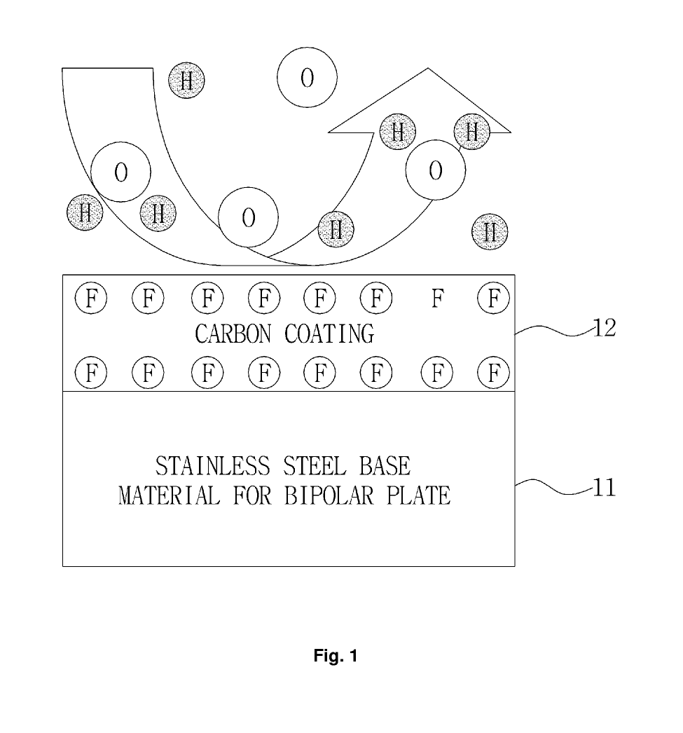

FIG. 1 is a schematic diagram showing a structure of a metallic bipolar plate for a fuel cell in which the surface of a stainless steel base material is doped with fluorine and coated with carbon in accordance with the present invention. As shown in the figure, a carbon coating layer 12 coated with fluorine (F) is formed on the surface of a stainless steel base material 11 for a bipolar plate to prevent the metallic bipolar plate from corroding, prevent a voltage drop due to a reduction in the electrical conductivity, and improve the water draining performance and heat radiating performance.

Preferably, the surface coating layer of the metallic bipolar plate in accordance with the present invention comprises a carbon coating layer doped with 25 to 35 AT. % of fluorine (F), and the carbon coating layer 12 is formed on the surface of the stainless steel base material 11 with a thickness of 0.5 to 2 μm. Here, the material for the metallic bipolar plate used in the present invention may be a commercially available stainless steel plate having a thickness of 0.1 to 0.2 mm (a ferritic stainless steel containing 12 to 16 wt % Cr or an austenitic stainless steel containing 16 to 25 wt % Cr and 6 to 14 wt % Ni). Since the price of the stainless steel plate is significantly lower than that of a graphite bipolar plate, it is possible to reduce the manufacturing cost and apply the stainless steel pate to a mass production process.

The carbon coating process is performed in a radio frequency (RF, 13.56 MHz) plasma assisted chemical vapor deposition (PACVD) apparatus, and a precursor required for the formation of the carbon coating layer may suitably comprise methane (CH₄) and carbon trifluoride (CHF₃).

At this time, the RF power applied to the apparatus is 100 W, the negative bias is 250 V, the vacuum is maintained below 10⁻⁴ Torr, and the flow rate of carbon trifluoride and methane (CHF3:CH4) is kept at 3.5 to 4.5:1, thus obtaining the carbon coating layer 12 having a thickness of 0.5 to 2 μm.

The hardness of the thus obtained carbon coating layer 12 is 16 to 19 GPa, and the amount of fluorine (F) contained in the coating layer should fall within 25 to 35 AT. %.

If the flow rate of carbon trifluoride and methane (CHF3:CH4) exceeds 4.5:1, the amount of fluorine (F) in the carbon coating layer exceeds 35 AT. %, and thereby the electrical properties can be deteriorated due to impurities. As a result, it is impossible to ensure the desired electrical conductivity, and the hardness is significantly reduced.

Whereas, if the flow rate is less than 3.5:1, the amount of fluorine (F) is less than 25 AT. %, and thereby a sufficient reduction in the surface energy, required for the water drainage and heat radiation, may not be achieved. As a result, it is impossible to achieve an improvement in water draining performance, and further the adhesive strength is reduced.

If the thickness of the carbon coating layer exceeds 2.0 μm, the electrical conductivity thereof can be lowered. On the other hand, if it is less than 0.5 μm, a sufficient adhesive strength of the coating layer may not be ensured, and further the reduction in the surface energy is insufficient.

Since the above-described metallic bipolar plate of the present invention basically comprises the carbon coating layer, it is possible to ensure the electrical conductivity and the corrosion resistance which are equivalent to those of the graphite bipolar plate. Especially, with the addition of fluorine, it is possible to additionally improve the water draining performance and the heat radiation performance without deteriorating the electrical conductivity and the corrosion resistance.

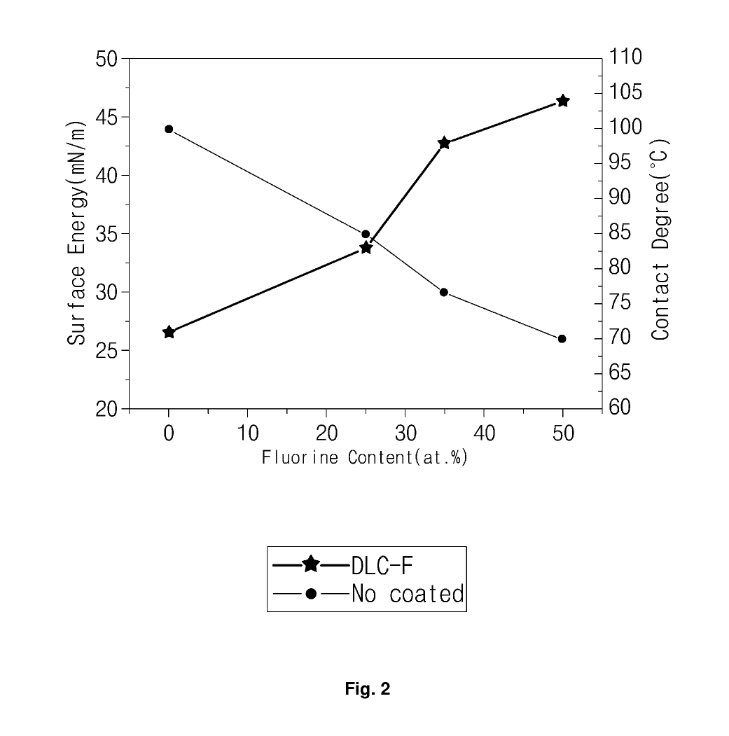

The surface energy in the fluorine-doped carbon coating layer in accordance with the present invention is in inverse proportion to the amount of fluorine as shown in FIG. 2. Moreover, the surface energy is generally expressed as a waterdrop contact angle. The contact angle is in inverse proportion to the surface energy and in proportion to the amount of fluorine. In general, since a material having a low surface energy is in a stable state, the material does not tend to react with another material, and thereby the waterdrop contact angle is increased. Contrarily, since a material having a high surface energy is in an unstable state, it tends to react with another material, and thereby the waterdrop contact angle is reduced.

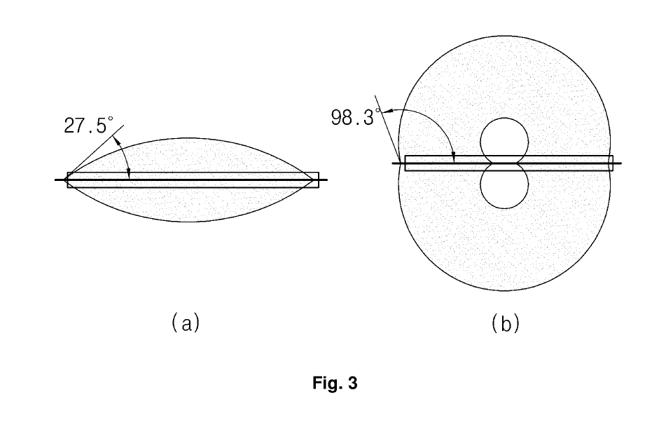

FIG. 3 is a diagram showing the waterdrop contact angle on the surface of a bipolar plate including a carbon coating layer doped with fluorine in accordance with the present invention (a) and on the surface of a bipolar plate including no carbon coating layer (b). It can be seen that the area where the waterdrop is in contact with the surface of the carbon coating layer in accordance with the present invention is reduced approximately 20%. The contact area is related to the water draining performance and the heat radiation performance, and the reduction in the contact area according to the present invention increases the contact area with air relatively, thus improving the water draining performance and the heat radiation performance of the bipolar plate.

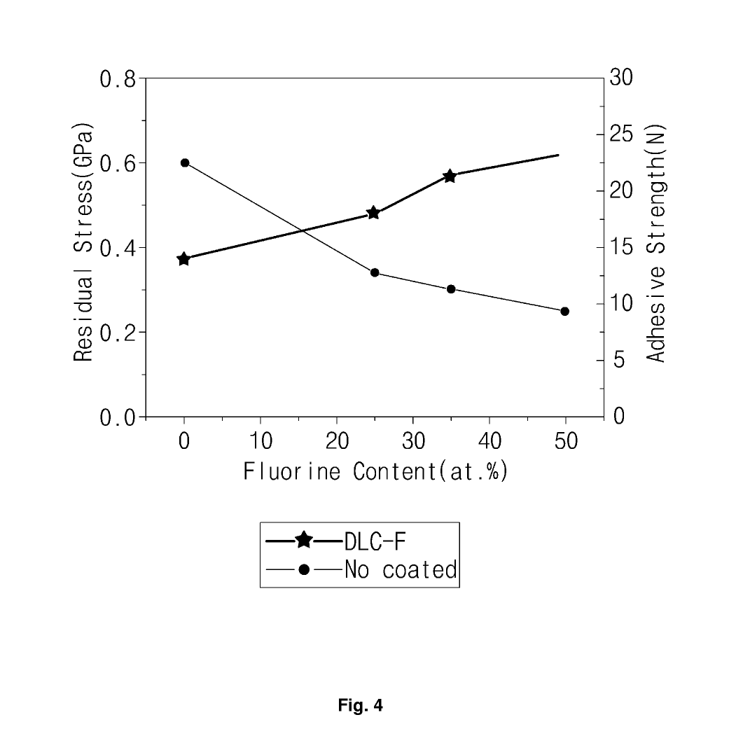

FIG. 4 is a diagram showing a reduction in residual stress and an increase in adhesive strength in a carbon coating layer with respect to fluorine content. If the amount of fluorine is increased, the residual stress in the carbon coating layer is reduced, which results in an improvement in the adhesive strength.

Meanwhile, a corrosion test and a contact resistant test were performed to compare the electrical performance (e.g., electrical conductivity) and durability characteristics of the stainless steel bipolar plate having the above-described surface layer according to the present invention (Example) and the stainless steel bipolar plate with no such surface layer (Comparative Example).

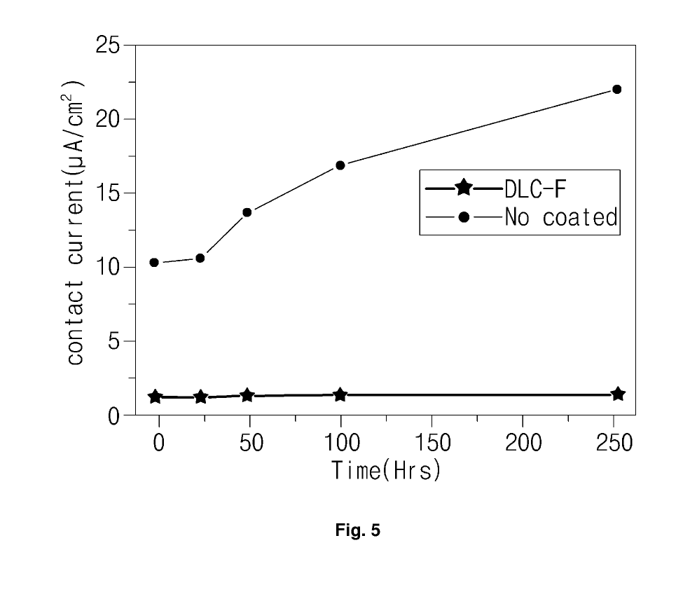

In the corrosion test, corrosion current according to time was measured. More specifically, a surface-treated bipolar plate having an area of 1 cm² (Example, DLC-F) was immersed in a mixed solution of 0.1 N sulfuric acid and 2 ppm hydrofluoric acid and then bubbling was maintained at 80° C. by supplying air. Subsequently, current density was measured using a potentiostat. For a non-coated bipolar plate having an area of 1 cm² (Comparative Example), same test was performed. The comparison test result is shown in FIG. 5.

Based on the requirements of the U.S. Department of Energy (DOE), the corrosion current should be approximately 1 μA/cm² or lower. As can be seen from FIG. 5, the non-coated bipolar plate in accordance with the Comparative Example had an initial corrosion current greater than that of the surface-treated bipolar plate in accordance with the Example and the corrosion current was increased with the lapse of time as the corrosion proceeded. On the contrary, in the bipolar plate in accordance, with the Example, a relatively low current of 0.45 μA/cm² was maintained constant and no corrosion occurred.

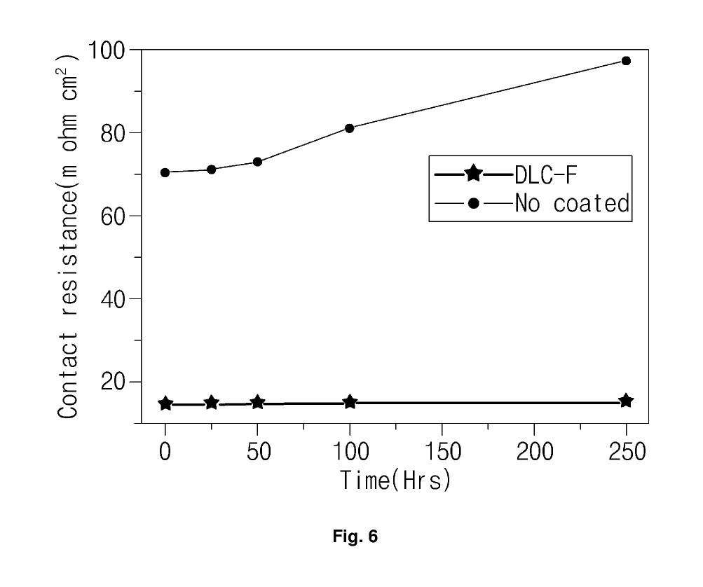

The contact resistance test was performed and the test result is shown in FIG. 6. According to the standard provided by the U.S. Department of Energy (DOE), the contact resistance is required to be about 25 mΩcm² or lower. In the non-coated bipolar plate (Comparative Example), the contact resistance was continuously increased from 72 mΩcm² at the beginning stage with the lapse of time. On the contrary, in the surface-treated bipolar plate (Example), a relatively low contact resistance of 15.1 mΩcm² was maintained constant, which shows the corrosion resistance was excellent.

As described above, with the carbon coating layer formed on the surface of the stainless steel base material, it is possible to provide a metallic bipolar plate having excellent electrical conductivity, corrosion resistance, water draining performance, heat radiating performance, and adhesive strength between the stainless steel and the surface coating layer.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

1-3. (canceled)

4. A method for forming a surface layer of a metallic bipolar plate for a fuel cell, the method comprising forming a carbon coating layer containing 25 to 35 AT. % of fluorine on the surface of a stainless steel base material for a fuel cell bipolar plate by a plasma assisted chemical vapor deposition, wherein carbon coating layer is formed using a precursor including methane (CH4) and carbon trifluoride (CHF3) gas.

5. The method of claim 4, wherein, in forming the carbon coating layer, the flow rate of carbon trifluoride and methane (CHF3:CH4) is kept at 3.5 to 4.5:1.

6. The method of claim 4, wherein the carbon coating layer has a thickness of 0.5 to 2 μm.

7. A metallic bipolar plate for a fuel cell comprising a carbon coating layer formed on the surface of a stainless steel base material thereof according to the method of claim 4.

8. The metallic bipolar plate for a fuel cell of claim 7, wherein the carbon coating layer has a hardness of 16 to 19 GPa.
